(19) United States
(12) Patent Application Publication
(10) Pub. No.: US 2013/0137790 A1
(43) Pub. Date: May 30, 2013

(54) Impact-Resistant Foam Composition

(71) Applicant: Nike, Inc., Beaverton, OR (US)

(72) Inventor: Cheng Hu, Beaverton, OR (US)

(73) Assignee: Nike, Inc., Beaverton, OR (US)

(21) Appl. No.: 13/689,989

(22) Filed: Nov. 30, 2012

Related U.S. Application Data
(60) Provisional application No. 61/565,175, filed on Nov. 30, 2011.

(51) Int. Cl. C08L 25/08

(52) U.S. Cl. CPC C08L 25/08
USPC 521/146

(57) ABSTRACT

A foam composition is provided. An exemplary foam composition comprises a polymer of styrene, ethylene, and butylene. The exemplary foam composition further comprises additional agents that enhance the foam composition's stability during industrial laundering and usage. As characterized by a peak tangent δ value around 19 degrees Celsius and a specific gravity below 0.16 g/cc, the foam composition is impact-resistant, lightweight, and resistant to shrinkage. Examples of the foam composition may be incorporated into garments as part of impact-resistant athletic attire.

### CROSS-REFERENCE TO RELATED APPLICATIONS

This application claims benefit of U.S. Provisional Application No. 61/565,175, filed Nov. 30, 2011, entitled “Impact-Resistant Foam Composition,” which is incorporated in its entirety by reference herein.

### STATEMENT REGARDING FEDERALLY SPONSORED RESEARCH OR DEVELOPMENT

Not applicable.

### TECHNICAL FIELD

The present invention relates to a foam composition. More particularly, the present invention relates to an exemplary foam composition for use in molded foam structures that can be integrated into a garment in a variety of configurations.

### BACKGROUND

Athletic gear performance may be evaluated both during and after competition or training. The stability of materials used in impact-resistant athletic gear is subject to extreme conditions during both use and cleaning. For example, well-worn impact-resistant gear needs to maintain flexibility when subject to cooler temperatures, such as during an outdoor event, while providing secure, cushioning protection against repeated force encountered during competition and/or training. Additionally, such gear may be washed repeatedly, and must resist shrinkage and maintain durability when cleaned, often at relatively high temperatures. An athlete may desire to wear impact-resistant athletic gear that is lightweight, provides reliable protection, and is resistant against the elements on the field and in the washer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An impact-resistant foam composition is provided. An exemplary impact-resistant foam composition comprises a polymer with at least one aromatic vinyl compound and at least one alkylene. The foam composition maintains one or more physical characteristics when subjected to washing at 60 degrees Celsius for at least 150 cycles and drying at 90 degrees Celsius for at least 150 cycles. In the exemplary foam composition, the aromatic vinyl compound may be styrene, and the alkylene may be ethylene. Additionally, the alkylene may be butylene. Exemplary physical characteristics may include a maximum hardness value of 40 Asker C at 20-22 degrees Celsius, and a maximum transmitted force less than or equal to 3.0 kN. Additionally, the one or more physical characteristics maintained even after washing may comprise a maximum shrinkage of a sheet of the foam composition. For example, a foam composition in accordance with the present invention may retain an original linear configuration such that a sheet of the foam composition reduces to no less than 97% of the original size of the sheet when maintained at 70 degrees Celsius for one hour, and may further comprise retaining an original linear configuration such that a sheet of the foam composition reduces to no less than 88% of the original size of the sheet when maintained at 120 degrees Celsius for one hour. The foam composition may further comprise a stabilizing compound that maintains a pH of the foam composition within a desired range, as well as one or more of the following: a blowing agent, a cross-linking agent, a lubricant, a colorant, a flame retardant, an anti-microbial compound, an anti-static compound, a filler, a thermally resistant polymer, and a curing accelerator.

An additional example comprises a foam composition comprising a polymer having a peak tangent δ value greater than or equal to 0.5, wherein the foam composition maintains one or more physical characteristics when subjected to washing at 60 degrees Celsius for at least 150 cycles and drying at 90 degrees Celsius for at least 150 cycles, and further wherein the peak tangent δ value of the foam composition occurs within a range of 10 degrees Celsius to 30 degrees Celsius. The polymer may comprise at least one styrene, at least one ethylene, and at least one butylene. The exemplary foam composition may further comprise one or more of the following: a blowing agent, a cross-linking agent, a lubricant, a colorant, a flame retardant, an anti-microbial compound, an anti-static compound, a filler, a thermally resistant polymer, and a curing accelerator. The physical characteristics may comprise a specified hardness, a resistance to shrinkage, and a specific gravity. Hardness may be characterized by a maximum hardness value of 40 as measured by an Asker C type durometer. Resistance to shrinkage may be characterized by retaining an original linear configuration such that the maximum shrinkage of a sheet of the foam composition reduces the sheet to no less than 97% of the original size of the sheet when maintained at 70 degrees Celsius for one hour, and retaining an original linear configuration such that the maximum shrinkage of a sheet of the foam composition reduces the sheet to no less than 88% of the original size of the sheet when maintained at 120 degrees Celsius for one hour. The peak tangent δ value of the exemplary foam composition may occur within a range of 10 degrees Celsius to 30 degrees Celsius. Additionally, the peak tangent δ value may occur at 19 degrees Celsius.

Another example comprises a foam composition comprising a polymer having a peak tangent δ value greater than or equal to 1.0, wherein the foam composition maintains one or more physical characteristics when subjected to washing at 60 degrees Celsius for at least 150 cycles and drying at 90 degrees Celsius for at least 150 cycles, and further wherein the peak tangent δ value of the foam composition occurs within a range of 10 degrees Celsius to 30 degrees Celsius. The specific gravity of the foam composition may be below 0.16 g/cc. Additionally, a sheet of the exemplary foam composition may shrink to a maximum of 92% of an original size of the sheet during industrial laundering.

### BRIEF DESCRIPTION OF THE DRAWINGS

Not Applicable.

### DETAILED DESCRIPTION

Athletic garments that incorporate impact-resistant technology provide added protection that reduces or eliminates the need for additional padding and frees the wearer of added bulk during movement. The flexible, lightweight foam incorporated into such impact-resistant technology needs to be both protective and malleable so that the wearer's performance is unhindered, perhaps even improved, by the protective gear. The present invention provides a lightweight foam composition for impact resistance that may be used as a component of protective gear for athletic competition and/or training that risks or involves potential physical impact to an athlete wearing the gear. Examples of the foam composition may be incorporated into impact-resistant garments. The foam composition resists shrinkage and maintains stability during washing. Additional examples of the foam composition resist hardness at lower temperatures.

The present invention may utilize a polymer, such as the hydrogenated styrenic elastomer provided by Asahi Kasei Chemicals Corporation, under the trade name S.O.E.™ L609 (Trial Grade) (L609). Such a polymer comprises a poly(styrene-ethylene-butylene-styrene) (SEBS) formulation, and is characterized according to Table 1 below.

TABLE 1
S.O.E.^{TM} - Grade No. L609 (Trial Grade)

| Property | Test Method | Test Condition | Units | L609 |
|---|---|---|---|---|
| Peak temp. of tangent δ | | | | 19° C. |
| Density | ISO 1183 | | g/cm³ | 1.00 |
| MFR | ISO 1133 | 190° C., 2.16 kgf | g/10 min | 2.5 |
| Hardness (after 10 sec.) | ISO 7619 | Durometer Type A | | 61° |
| 100% tensile stress | ISO 37 | Dumbbell: Type A | MPa | 2.0 |
| 300% tensile stress | ISO 37 | Dumbbell: Type A | MPa | 4.0 |
| Tensile strength | ISO 37 | Dumbbell: Type A | MPa | 26.0 |
| Elongation | ISO 37 | Dumbbell: Type A | % | 640 |
| Dunlop rebound | BS 903 | 23° C. | % | 5 |
| resilience | | | | |

An example of the formulation for the present invention comprises the components characterized in Table 2 below. This exemplary formulation comprises a poly(SEBS) component, such as L609 described above, as well as additional agents. It has been contemplated that additional components may be added to the exemplary formulation in Table 2, and that one or more of the components listed in Table 2 may be removed, replaced, or altered in concentration. Additionally, the components in Table 2 are measured in parts per hundred resin (PHR).

TABLE 2

| Material | PHR |
|---|---|
| Asahi Kasei L609 | 50-100 |
| Polymer B | 0-50 |
| CaCO₃ | 5 |
| Stearic acid | 1.5 |
| ZnO | 0.6 |
| SiO₂ | 7 |
| Dicumyl Peroxide | 0.4 |
| Azodicarbonamide | 12 |

The amount of some components of a foam may vary from the precise amounts given in Table 2 and/or may be selected from the approximate ranges described. For example, Asahi: Kasei L609 may be used at an amount of approximately 70 parts per hundred resin and thermally resistant polymer B may be used at an amount of approximately 30 parts per hundred resin.

Various modifications to the exemplary foam formulation of the present invention are contemplated. Further optimization of the formulation may enhance the features described above, including impact resistance, physical tensile and tear strength, and stability during washing. Exemplary foam compositions comprise one or more of the following: a blowing agent, a cross-linking agent, a lubricant, a filler, and a curing accelerator. Additional stabilizers may be added to the present invention to further improve the resilient nature of the foam composition, and to enhance additional features during wear and washing. Such enhancements may include the addition of colorants and pigments, flame retardants, anti-microbial compounds, antistatic agents, thermally resistant polymers, pH-controlling agents, and the like.

An example of a specification for the foam composition of the present invention is described in Table 3 below.

TABLE 3
Foam Specification

| Property | Test Method | Unit | Compliance |
|---|---|---|---|
| Density/specific gravity | ASTM D-792 | g/cc | Max. 0.16 |
| Thermal linear shrinkage | Foam sheet, 20 cm (L) × | % of original | 3 (70° C. 1 hr) Max. |
| | 10 cm (W) × 1cm (H) | size | 12 (120° C. 1 hr) Max. |
| Hardness | ASTM D-2240 | Asker C | Min. 30 |
| | | | Max. 40 @ 20-22° C. |
| Impact Resistance | Impact attenuation drop test @ 3 | kN | Max. 3.0 |
| | Joules, 6 mm thick sheet | | |
| Tensile Strength | ASTM D-412 | Kg/cm² | Min. 10.0 |
| Tear | ASTM D-624 | Kg/cm | Min. 5.0 |
| Split Tear | ASTM D-3574F | Kg/cm | Min. 1.2 |
| Compression Set | ASTM D-395 | % | Max. 80 |
| Industrial laundry durability | 60° C. wash, 90° C. dry, 150 cycles | | Pass |

It has been contemplated that the present invention may meet or exceed the exemplary specifications described in Table 3. For example, the specific impact performance of the foam composition may fall below the specification requiring a maximum of 3.0 kN. The impact performance of a foam in accordance with the present invention may be quantified in various ways, but is described in Table 3 based upon the impact testing method set forth in European Standard EN 13277-1, entitled “Protective Equipment for Martial Arts.” Additionally, it has been contemplated that additional requirements may be added to the exemplary specification in Table 3, and that one or more of the test properties or test methods listed in Table 3 may be removed, replaced, or altered in measurement or range. For example, the minimum hardness of the foam composition could be as low as 30 on an Asker C type durometer, while maintaining the desired flexibility and impact-resistance of the present invention.

As noted by a “passing” value in Table 3, industrial laundry durability provides an indication of several factors associated with the repeated use and washing of the foam composition, and of a product into which the foam composition may be incorporated. For example, industrial laundry durability provides an indication of the foam composition's resistance to shrinkage, delamination, and hardening during repeated washing and drying. As such, the present invention may be incorporated into an item of athletic gear that is subject to repeated washing and drying, while maintaining other exemplary features of performance and stability.

In one example, the foam composition demonstrates resistance to laundering under conditions at least as warm as 60° C. in a washing machine, and 90° C. in a dryer. It has been contemplated that the foam composition may also exceed the industrial laundry durability specification described in Table 3, and that the foam composition may be able to withstand higher washing temperatures and higher drying temperatures for an additional number of cycles.

In addition to the exemplary specification of Table 3, some additional features of the foam composition may be characterized according to particular measurable parameters. For example, the temperature of the peak tangent δ value for the foam composition may be evaluated, and the specific gravity of the foam composition may be determined. It has been contemplated that additional measurable parameters may characterize the impact resistance, hardening, and washing stability of the foam composition.

An exemplary impact-resistant foam composition comprises a polymer having a peak tangent δ value greater than or equal to 0.5. Another exemplary impact-resistant foam composition comprises a polymer having a peak tangent δ value greater than or equal to 1.0. In one example, the peak tangent δ value occurs in the range of 0-30° C. As such, the impact absorption of the foam composition is optimized when the peak tangent δ value occurs within this range. In one example, the peak tangent δ value of the present invention occurs around 19° C. Additionally, the specific gravity of one example of the foam composition is below 0.16 g/cc. In some examples, the specific gravity of the foam composition is at or below 0.12 g/cc. As part of the present invention, properties such as specific gravity and peak tangent δ values are maintained during repeated use and washing of impact-resistant gear that incorporates the foam composition.

The foam composition may be integrated into a variety of garments, such as an item of athletic apparel used for impact resistance. In one example, the integration of the foam composition into an apparel item may be done using a pocket or pouch attached to the garment, into which the foam composition may be placed. Additionally, another example of incorporating the foam composition into a garment includes attaching the foam composition directly to the garment, such as by gluing or sewing the foam to a surface of the garment. It has been contemplated that a number of different attachment methods may be used to integrate the foam composition into a garment, including both direct and indirect applications or processes.

It has also been contemplated that a number of arrangements of the foam composition may be used when incorporating the foam composition in a garment. For example, the foam composition may be attached to the garment in a geometrical configuration. In another example, the foam composition may be arranged in a particular orientation for optimal compression resistance and impact absorption. In a further example, the foam composition may be attached to a garment with an additional stabilizing feature, such as an additional coating or stabilizer that enhances the resilience of the foam composition.

The present invention has been described in relation to particular examples, which are intended in all respects to be illustrative rather than restrictive. Alternative examples will become apparent to those of ordinary skill in the art to which the present invention pertains without departing from its scope.

From the foregoing, it will be seen that this invention is one well adapted to attain all the ends and objects set forth above, together with other advantages which are obvious and inherent. It will be understood that certain features and subcombinations are of utility and may be employed without reference to other features and subcombinations. This is contemplated by and is within the scope of the claims.

Having thus described the invention, what is claimed is:

1. A foam composition comprising:
a polymer comprising at least one aromatic vinyl compound and at least one alkylene,
wherein the foam composition maintains one or more physical characteristics when subjected to washing at 60 degrees Celsius for at least 150 cycles and drying at 90 degrees Celsius for at least 150 cycles.

2. The foam composition of claim 1, wherein the at least one aromatic vinyl compound comprises styrene.

3. The foam composition of claim 1, wherein the at least one alkylene is ethylene.

4. The foam composition of claim 1, wherein the at least one alkylene is butylene.

5. The foam composition of claim 1, wherein the one or more physical characteristics comprises a maximum hardness value of 40 on an Asker C type durometer at 20-22 degrees Celsius.

6. The foam composition of claim 1, wherein the one or more physical characteristics comprises a maximum transmitted force of 3.0 kN.

7. The foam composition of claim 1, wherein the one or more physical characteristics comprises retaining an original linear configuration such that the maximum shrinkage of a sheet of the foam composition reduces the sheet to no less than 97% of the original size of the sheet when maintained at 70 degrees Celsius for one hour.

8. The foam composition of claim 1, wherein the one or more physical characteristics comprises retaining an original linear configuration such that the maximum shrinkage of a sheet of the foam composition reduces the sheet to no less than 88% of the original size of the sheet when maintained at 120 degrees Celsius for one hour.

9. The foam composition of claim 1, further comprising a stabilizing compound that maintains a pH of the foam composition within a desired range.

10. The foam composition of claim 1, further comprising one or more of the following:
a blowing agent;
a cross-linking agent;
a lubricant;
a colorant;
a flame retardant;
an anti-microbial compound;
an anti-static compound;
a filler;
a thermally resistant polymer; and
a curing accelerator.

11. A foam composition comprising:
a polymer having a peak tangent δ value greater than or equal to 0.5,
wherein the foam composition maintains one or more physical characteristics when subjected to washing at 60 degrees Celsius for at least 150 cycles and drying at 90 degrees Celsius for at least 150 cycles,
and further wherein the peak tangent δ value occurs within a range of 10 degrees Celsius to 30 degrees Celsius.

12. The foam composition of claim 11, wherein the polymer comprises at least one styrene, at least one ethylene, and at least one butylene.

13. The foam composition of claim 11 further comprising one or more of the following:
a blowing agent;
a cross-linking agent;
a lubricant;
a colorant;
a flame retardant;
an anti-microbial compound;
an anti-static compound;
a filler;
a thermally resistant polymer; and
a curing accelerator.

14. The foam composition of claim 11, wherein the one or more physical characteristics comprises:
a hardness;
a resistance to shrinkage; and
a specific gravity.

15. The foam composition of claim 14, wherein the hardness is characterized by a maximum hardness value of 40 on an Asker C type durometer at 20-22 degrees Celsius.

16. The foam composition of claim 14, wherein the resistance to shrinkage is characterized by retaining an original linear configuration such that the maximum shrinkage of a sheet of the foam composition reduces the sheet to no less than 97% of the original size of the sheet when maintained at 70 degrees Celsius for one hour, and retaining an original linear configuration such that the maximum shrinkage of a sheet of the foam composition reduces the sheet to no less than 88% of the original size of the sheet when maintained at 120 degrees Celsius for one hour.

17. The foam composition of claim 11, wherein the peak tangent δ value occurs at 19 degrees Celsius.

18. A foam composition comprising:
a polymer having a peak tangent δ value greater than or equal to 1.0,
wherein the foam composition maintains one or more physical characteristics when subjected to washing at 60 degrees Celsius for at least 150 cycles and drying at 90 degrees Celsius for at least 150 cycles,
and further wherein the peak tangent δ value occurs within a range of 10 degrees Celsius to 30 degrees Celsius.

19. The foam composition of claim 18, wherein the specific gravity of the foam composition is below 0.16 g/cc.

20. The foam composition of claim 18, wherein the average shrinkage of a sheet of the foam composition reduces the sheet to no less than 88% of the original size of the sheet after 25 cycles of industrial laundering.
